(19) United States
(12) Patent Application Publication
(10) Pub. No.: US 2014/0157141 A1
(43) Pub. Date: Jun. 5, 2014

(54) SYSTEMS AND METHODS FOR CONTROLLING A USER'S ABILITY TO BROWSE THE INTERNET

(71) Applicant: EMO2 INC., Palo Alto, CA (US)

(72) Inventor: Mir Abid HUSSAIN, Kerala (IN)

(73) Assignee: EMO2 INC., Palo Alto, CA (US)

(21) Appl. No.: 13/691,004

(22) Filed: Nov. 30, 2012

(51) Int. Cl. G06F 3/01

(52) U.S. Cl. CPC G06F 3/01
USPC 715/741

(57) ABSTRACT

In a touch sensitive display system that can simultaneously receive inputs from and provide outputs to users through a touch sensitive display screen and that includes an Internet browser that can provide a controlled access to the Internet, wherein the browser includes a user interface for providing browser windows and a configuration interface including configuration panels, a method for controlling a user's ability to browse the Internet using the browser in accordance with a set of rules that places restrictions on Internet sites to which the user can navigate, is provided. The method includes: providing the configuration interface to a first user for configuring the browser with a set of rules and storing the rules in the browser; providing the user interface to receive from one of the second users an Internet site address to which the second user desires to navigate after the second user logs into the system.

### CROSS REFERENCE TO RELATED APPLICATIONS

This application is related to the following applications filed concurrently herewith on Nov. 30, 2012:

U.S. patent application Ser. No. ______, entitled “Systems and Methods for Changing Orientation of Display Windows and Contents;”

U.S. patent application Ser. No. ______, entitled “Systems and Methods for Authenticating a User Based on Multiple Inputs Received from Multiple Devices;”

U.S. patent application Ser. No. ______, entitled “Systems and Methods for Selectively Delivering Messages to Multiuser Touch Sensitive Display Devices;”

U.S. patent application Ser. No. ______, entitled “Systems and Methods for Processing Simultaneously Received User Inputs;” and

U.S. patent application Ser. No. ______, entitled “Apparatus and Methods for Mounting a Multiuser Touch Sensitive Display Device.”

### FILED OF THE INVENTION

The disclosed subject matter relates to the field of internet browsing, and more particularly but not exclusively to selectively controlling the ability to browse internet.

### DISCUSSION OF THE RELATED FIELDS

Adoption of internet has increased over the years, and continues to increase substantially. With the increased adoption of internet, users have started to depend on internet in their day-to-day activities. Hence, users expect to have internet connectivity wherever they go, not just on their personal devices, but also on devices that might be publicly available.

The need to enable internet access to users has been realised by establishments. Establishments, such as, restaurants, cafes and airports, among others, enable users to access the internet, either through the devices made available by the establishments or by enabling users to connect their devices to the establishments' network.

Most establishments either charge users a fee for accessing internet or access is made available free of cost. When establishments charge users a fee for accessing internet, the users might decide against using the internet facility made available by the establishment or they might even choose not to visit the establishment. There could be a scenario wherein the establishments would want users to access at least some of the websites, which might to favourable to the establishments' business. However, when users choose not to use the internet, the establishments fail to effectively engage with their users. In another scenario, wherein the users decide not to visit an establishment due to the fee charged for internet access, the establishment looses valuable customers.

On the other hand, if internet is made available free of cost to the users, then users might start consuming undesirable amount of data, thereby adding to the expenses of the establishment. Further, such free access may not enable the establishment to effectively engage with their customers by showcasing desirable websites.

### SUMMARY

In light of the foregoing discussion, there is a need for a technique to enable controlled access to users, thereby enabling establishments to effectively engage with their users.

Accordingly the invention provides a system for controlling the ability to browse the internet. The system includes a control panel enabling configuration of rules for browsing internet by users using internet browser deployed on one or more devices with which the system is communicating. The system also includes a rules module configured to store the rules configured using the control panel.

There is also provided a method for controlling the ability to browse the internet. The methods proposed include configuring rules for browsing internet directly into the browser that users use to browse the internet or control the usage across multiple devices by having the rules on a server to which the browsers available on these devices communicate with to download the rules prior to navigating to any webpage. For example, if an establishment finds it favourable for you to visit website xyz.com however does not wish you click any of the advertisements on xyz.com and navigate away from xyz.com, it could have the rule configured into the browser. This way the user is captive to xyz.com. The same establishment may later grow and want to deliver similar rules across all the devices under its control. This time the establishment will store its rules on a server to which all the browsers on xyz machines will connect to first prior to navigating to any webpage. These rules are now applied across the network and may work well for most cases however there might come a time when the establishment may want to give greater control to certain users while restricting the other users. The same web browser maybe individually programmed with rules for a particular user or the server could hold rules for that user.

In a touch sensitive display system that can simultaneously receive inputs from and provide outputs to a plurality of users through a touch sensitive display screen and that includes an Internet browser that can provide a controlled access to the Internet, wherein the Internet browser includes a user interface for providing at least one browser window and a configuration interface including at least one configuration panel, a method for controlling a user's ability to browse the Internet using the Internet browser in accordance with a set of rules that places restrictions on Internet sites to which the user can navigate, is provided. The method includes providing the configuration interface to a first user for configuring the Internet browser with a set of rules related to an ability to browse the Internet that can apply to at least one of a plurality of second users and storing the set of rules in the Internet browser; providing the user interface to receive from one of the plurality of second users an Internet site address to which the second user desires to navigate after the second user logs into the touch sensitive display system; if the Internet browser is configured with at least one rule related to an ability for the second user to browse the Internet, displaying on one of the at least one browser window at least a part of contents that is provided by an Internet site associated with the requested Internet site address; and if the Internet browser is not configured with at least one rule related to the second user's ability to browse the Internet, establishing a network connection with a server to request for a set of rules for controlling an ability to browse the Internet that can be applied to the second user.

### BRIEF DESCRIPTION OF DRAWINGS

Embodiments are illustrated by way of example and not limitation in the Figures of the accompanying drawings, in which like references indicate similar elements and in which:

FIG. 1 illustrates a system 100 configured to control the ability to browse internet, in accordance with an embodiment;

FIG. 2 illustrates control panel 102, in accordance with an embodiment;

FIG. 3 illustrates control panel 102 configured to limit the ability to browse internet based on number of web pages accessed by users, in accordance with an embodiment;

FIG. 4 illustrates a broad architecture configured to control the ability to browse internet, in accordance with an embodiment;

FIG. 5 is a flow chart illustrating a method to control the ability to browse internet, in accordance with an embodiment; and

FIG. 6 illustrates a flow chart for deploying rules to control the ability to browse internet using a device, in accordance with an embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

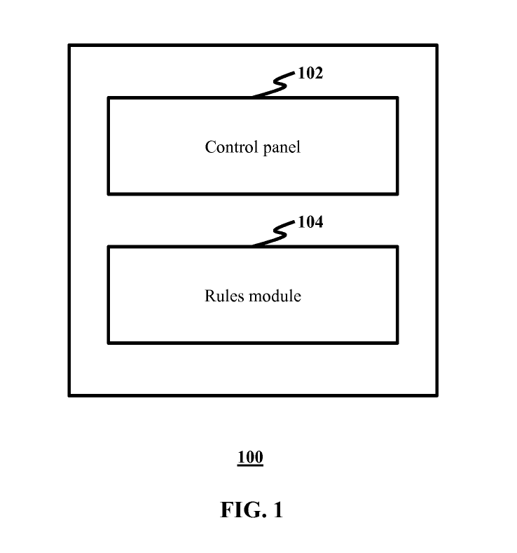

Embodiments disclose technique for controlling the ability to browse internet. FIG. 1 illustrates a system 100 configured to control the ability to browse internet, in accordance with an embodiment. System 100 includes a control panel 102 and a rules module 104. System 100 is configured to communicate with internet browser deployed on devices in which the ability to browse internet is desired to be controlled.

In an embodiment, system 100 communicates with the devices over a communication network. The communication network can be a wireless, wired or a combination of wireless and wired networks. Further, the communication network can be a Local Area Network (LAN) or a Wide Area Network (WAN).

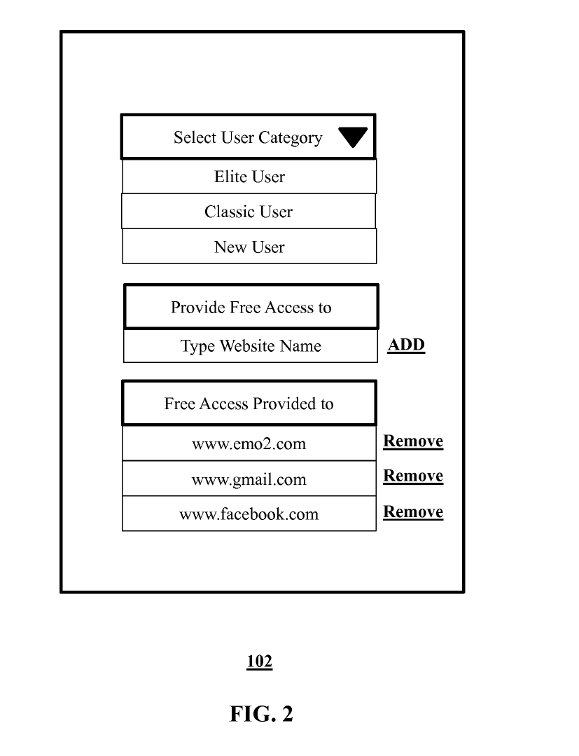

Control panel 102 enables an administrator to configure rules for browsing internet by users using internet browser deployed on one or more devices with which system 100 is communicating. FIG. 2 illustrates control panel 102, in accordance with an embodiment. As illustrated, an administrator can use the control panel 102 to add and remove websites to which free access is provided. Further, the administrator can specify the websites to which free access is provided, based on the category of users, who try to browse internet using the devices.

In an embodiment, the administrator can specify the websites to which free access is provided or can define the fee charged to the users for accessing certain websites. The fee defined by the administrator can be discounted as compared to the nominal internet browsing charges.

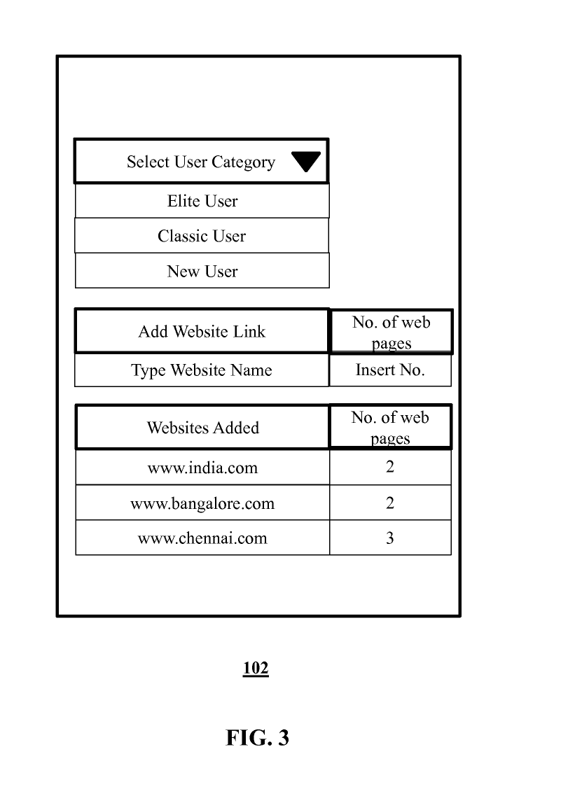

In an embodiment, control panel 102 is configured to enable limiting the ability to browse internet based on number of web pages accessed by users. FIG. 3 illustrates control panel 102 configured to limit the ability to browse internet based on number of web pages accessed by users, in accordance with an embodiment. As illustrated, the administrator can define the number of web pages a user can access under a domain.

In an embodiment, the restriction based on the number of pages can be added exclusively or in conjunction with the one or more limitations discussed in conjunction with FIG. 2.

In an embodiment, the administrator can restrict browsing based on the number of web pages accessed by the user by doing one or more of, specifying websites and the corresponding limitation, specifying the number of web pages viewable by the user under any unspecified domain and number of web pages viewable by the user.

The system, for example, provides the establishments the freedom to influence the internet browsing behaviour of its customers, thereby allowing the establishments to engage with their users. An establishment, for example, can effectively engage with their users by providing free access to browse web pages belonging to the establishment, while charging a fee to access other web pages.

A person skilled in the art will appreciate the fact that, system 100 enables establishments using the system to control browsing capability without relying on generic browsing limitations enforced by the Internet Service Provider (ISP).

In an embodiment, the rules defined using control panel 102 are stored in rules module 104.

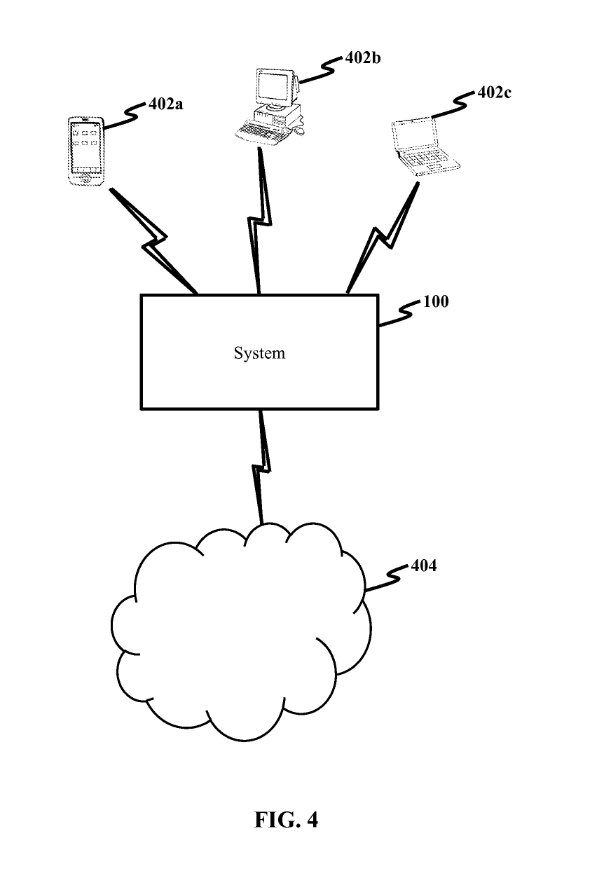

In an embodiment, internet browsing is enabled by routing access to internet through system 100. FIG. 4 illustrates a broad architecture configured to control the ability to browse internet, in accordance with an embodiment. System 100 is configured to communicate and control internet browsing on devices 402a, 402b and 402c (collectively referred to as devices 402). Users of devices 402 use the internet browser deployed on each of the devices 402 to gain access to internet. The request to browse internet is sent to system 100. System 100 applies rules specified for restricting browsing when it receives requests from devices 402. Based on the rules, users of the devices 402 are permitted to browse the internet.

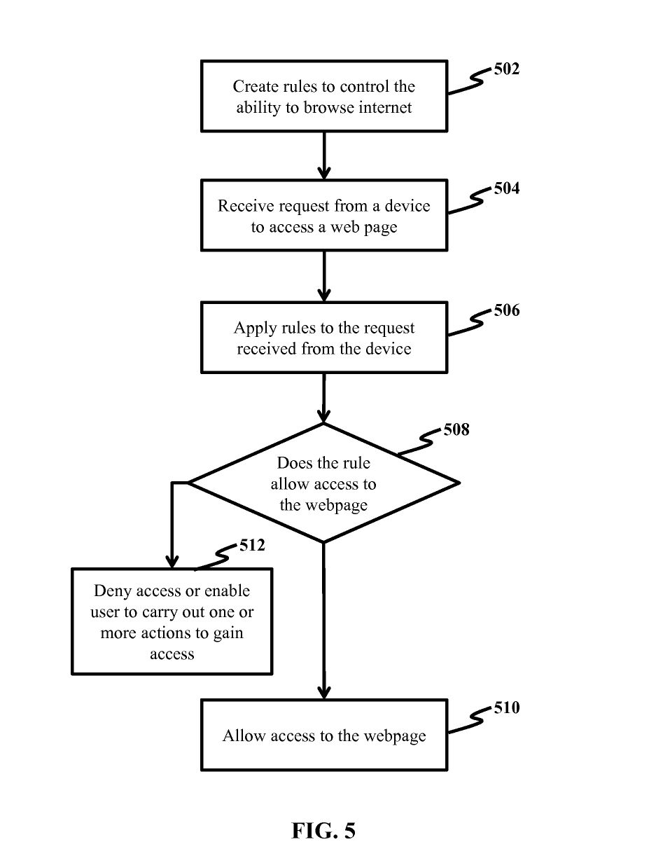

FIG. 5 is a flow chart illustrating a method to control the ability to browse internet, in accordance with an embodiment. At step 502, control panel 102 is used to define rules for controlling the ability to browse internet. The defined rules may be stored in rules module 104. When a user of a device, example, device 402a, uses internet browser deployed in device 402a to access a webpage, the request to access the web page is sent to system 100, at step 504. System 100, at step 506, applies rules defined at step 502 to the request received from the device 402a. If the request is such that the rules permit access to the webpage, then access to the web page is provided at step 510. Alternatively, if the request is such that the rules do not permit access to the webpage, then access to the web page is denied. On the other hand, the user may be requested to perform certain actions, such as, enabling a payment to be made, to permit access to the web page.

In an embodiment, rules module 104 is deployed on the devices through which users attempt to browse the internet.

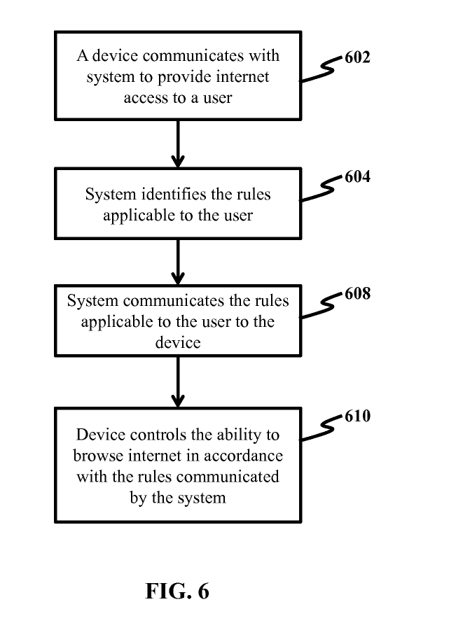

In another embodiment, internet browser deployed on a device, such as, device 402a, is configured to communicate with a local rules module, which is also deployed on device 402a. FIG. 6 illustrates a flow chart for deploying rules to control the ability to browse internet using a device, in accordance with an embodiment. For example, a user accesses a device, such as, device 402b, to browse the internet. Subsequently, at step 602, device 402b communicates with system 100 to enable the device 402b take a decision regarding granting access to the internet. System 100, after receiving communication from device 402b, wherein such communication can include information about the user, at step 604, identifies rules that are applicable to the user. In an embodiment, the rules are defined using control panel 102. The identified rules are communicated to device 402b by system 100, at step 608. Subsequently, at step 610, device 402b controls the ability of the user to browse internet using device 402b in accordance with the rules communicated by the system.

It shall be noted that, in the above embodiment, once rules are communicated to device 402b, request by the user to access a webpage is handled by device 402b, instead of forwarding such requests to system 100.

In an embodiment, the user activities on device 402b are logged. Such a log can be communicated to system 100.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. In a touch sensitive display system that can simultaneously receive inputs from and provide outputs to a plurality of users through a touch sensitive display screen and that includes an Internet browser that can provide a controlled access to the Internet, wherein the Internet browser includes a user interface for providing at least one browser window and a configuration interface including at least one configuration panel, a method for controlling a user's ability to browse the Internet using the Internet browser in accordance with a set of rules that places restrictions on Internet sites to which the user can navigate, the method comprising:
providing the configuration interface to a first user for configuring the Internet browser with a set of rules related to an ability to browse the Internet that can apply to at least one of a plurality of second users and storing the set of rules in the Internet browser;
providing the user interface to receive from one of the plurality of second users an Internet site address to which the second user desires to navigate after the second user logs into the touch sensitive display system;
if the Internet browser is configured with at least one rule related to an ability for the second user to browse the Internet, displaying on one of the at least one browser window at least a part of contents that is provided by an Internet site associated with the requested Internet site address; and
if the Internet browser is not configured with at least one rule related to the second user's ability to browse the Internet, establishing a network connection with a server to request for a set of rules for controlling an ability to browse the Internet that can be applied to the second user.
